(19) United States
(12) Patent Application Publication
(10) Pub. No.: US 2022/0147996 A1
(43) Pub. Date: May 12, 2022

(54) OFFLINE PAYMENT SYSTEM AND METHOD

(71) Applicant: MARGO NETWORKS PVT.LTD., Mumbai (IN)

(72) Inventors: Rohit Paranjpe, Mumbai (IN); Ripunjay Bararia, Mumbai (IN)

(73) Assignee: MARGO NETWORKS PVT.LTD., Mumbai (IN)

(21) Appl. No.: 17/511,272

(22) Filed: Oct. 26, 2021

(30) Foreign Application Priority Data
Nov. 11, 2020 (IN) 202021049250

(51) Int. Cl. G06Q 20/40; G06Q 20/38; G06Q 20/12

(52) U.S. Cl. CPC G06Q 20/401; G06Q 20/123; G06Q 20/389

(57) ABSTRACT

An offline payment system and method allowing a user to conduct a payment transaction during different periods of connectivity of the various portions of the offline payment system. The offline payment system may include an SDK integrated into a payment application, an edge server, cloud infrastructure and a payment system.

### PRIORITY CLAIMS/RELATED APPLICATIONS

This application claims priority under 35 USC 119(a) to Indian Patent Application Serial No. 202021049250, filed Nov. 11, 2020 and entitled “Offline Payment System and Method”, the entirety of which is incorporated herein by reference.

### FIELD

The disclosure relates to a system and method for providing a technical solution for offline payments and more specifically to an offline payments system and method for use in an Edge computing and/or content delivery system.

### BACKGROUND

Today, Digital services (Websites, Apps, etc.) can only monetize when the user (user device on which the Digital service is being accessed) has seamless connectivity to the Internet. The Payment industry suffers substantial revenue+opportunity losses due to failed transactions attributable to patchy or unstable Internet connections. In addition to this, the reach of the digital payments industry gets limited only to users having an active Internet connection/access to a Wi-Fi connection or only to instances where users are in places or areas with available internet networks. This is a known technical problem of existing payment systems.

There are also companies worldwide that are setting up disconnected digital consumption platforms (Local Wi-Fi/Wireless LAN based systems in aircrafts, buses, trains, remote areas, etc.). These platforms today can only offer ad monetized content or must charge the consumer in advance to use such systems or stock pre-paid coupons that a consumer can purchase using cash which is another technical problem of known systems.

FIG. 1 illustrates a typical payment flow. For example, using an example of an in-store purchase via a point of sale (POS) machine, connected to broadband internet. The process of transaction for a customer is shown in FIG. 2. The flow in FIG. 2 works in perfect payment scenarios wherein there's no failure at any stage during the transaction. Hence, advancements like Contactless Payment, bring in efficiency in payments even if marginally cuts down time to transact. When a user transacts online on e-commerce stores, while there is no physical card swipe or insert, card details do need to be entered for transaction. Here, features built by Payment Gateways like Saved Cards and non-OTP (also known as Additional Factor for Authentication—AFA) transactions, bring down the overall time to transact for a user. However, these known systems still suffer from being unable to perform payments if there is a failure of the payment system such as a lack of connectivity to the payment system.

### Current Internet Connectivity and Availability

Globally, about 59% of the population is connected to the internet either via mobile internet or via broadband connectivity, as per reports from July 2020 as described in datareportal.com/reports/digital-2020-july-global-statshot that is incorporated herein by reference. Globally, the average 4G availability across the most populated 100 countries is around 85%. This availability holds true for 70% of the global population. The remaining 30% population is not even connected to the internet or does not have access to 4G infrastructure. Thus, the weighted average 4G availability globally is pegged at around 60%.

### Current Internet Latency

Globally, the average latency across even 4G networks did not cross the under 30 milliseconds milestone. The most recent statistics for average global latency stands at 40 ms, while the average latency in developing nations is far worse. Measured in milliseconds, latency refers to the delay users experience as data makes a round trip through the network. LTE Networks can operate with a latency up to 10 ms even on the 1800 MHz spectrum, which is widely adopted across global telecom operators. Nonetheless, due to network congestion, the latency is 4-7 times higher than optimal across countries. During the COVID-19 pandemic, a mobile experience report suggests that the average deterioration of internet speed was pegged at an average of 15-20% across 42 countries that the survey was carried out across, during the period March 2020-May 2020. Given the LTE coverage, availability, congestion and latency across the world and telecom providers—network failures resulting in transaction timeout cause >20% online payment failures, as per annual industry data. Thus, it is desirable to provide a technical solution that can facilitate payment transactions during network failures or when the client device is offline.

In 2020, smartphones are owned by 3.5 billion people which is a 45% coverage of people worldwide. Given that still a majority of the population is not transacting online via smartphones, multiple countries across Asia and Africa have adopted USSD (Unstructured Supplementary Service Data) as a mechanism to enable people to transact via even non-smartphones. USSD works on the GSM protocol, which is still widely available in these countries, whereas the LTE availability is limited or expensive. USSD signals are not prioritised in countries like India, since LTE signals are prioritised within the spectrum, thus leading to higher session volume drops. The overall security of the USSD service is quite low and it's usage experience is quite cumbersome for end users. Also, USSD sessions are stateless, which means the user needs to go through the entire process again if it fails in between. Thus, while USSD has the potential to drive higher transactions in the underserved market, because of higher session drops, reduced security and signal priority and a poor user experience, it could not become an alternative payment mechanism for unconnected regions.

Interactive voice response (IVR) based systems have been developed and permitted for usage for carrying out transactions as a Fast Payments System across multiple countries in the world. IVR Payments allow customers to make payments by entering their card data via touch tones—at any time of the day or night—without speaking to an agent or accessing a website. The volume of transactions through IVR is pretty low, because of the following reasons: 1) High abandonment; 2) Complex IVR menus; 3) Low personalisation; and 4) Mandatory Additional Factor for Authentication (OTP, PIN). Thus, this IVR solution does not solve the technical problem of offline payments.

A prepaid wallet is an electronic wallet that can be used to perform financial transactions. Prepaid wallets can be closed-loop wallets or semi-closed loop wallets. Closed-loop wallets allow users to add money to the virtual prepaid wallet for usage only on that particular app or website and it cannot be used as a payment instrument on other websites nor can the user redeem the balance or transfer to the bank. Semi-closed loop wallets allow users to load money and transact on other apps and websites via its platform. Because of the verification, prepaid wallet users need to go through a multi-step process to activate their wallets to begin transacting or link an existing payment instrument (like a debit card) to activate their wallets. The continuous recharging of wallets for transactional usage is one of the friction points during user transaction experience.

Contactless payment mechanisms also exist. The contactless payment mechanism uses Near Field Communication (NFC) capabilities of the card and the POS machine to initiate transactions on the user's card without dipping or swiping the card into the machine. The problem with contactless payment in-store is due to low penetration of contactless cards in the world, at only 6% of the total transactions (in value) coming through contactless cards. While inserting the card and entering the PIN processes are eliminated, the underlying architecture still heavily relies on internet availability and connectivity to process a transaction and thus still does not solve the technical problem described above.

Sound wave-based payments utilise the sound waves to transmit packets of encrypted data between the sender (payee) and the receiver (merchant POS). This technology converts any POS machine into a contactless payment medium. The user can simply open their app and accept requests for transactions from the merchant by making the app listen for the merchant's sound wave. The drawback with this system is that while it is just a software add-on at the consumer's end, the success of this system depends on merchants' soundwave-enabled POS adoption which has been less than stellar. Again, this existing system does not address or overcome the above technical problem and thus it is desirable to provide an offline payment system that overcome the above technical problem using a technical solution and it is to this end that the disclosure is directed.

### BRIEF DESCRIPTION OF THE DRAWINGS

FIG. 1 is a diagram showing a current payment process;

FIG. 2 is a traditional EMV chip card transaction flow;

FIG. 3 is a hardware diagram of an Edge computing appliance and/or a content delivery network that includes the offline payment system;

FIG. 4 shows more details of the system in FIG. 3

FIG. 5 illustrates a novel method for global offline payment processing;

FIG. 6 illustrates a user onboarding process for global offline payments;

FIG. 7 illustrates further details of the architecture and information flow for global offline payments;

FIGS. 8A and 8B illustrate more details of the transaction flow for global offline payments;

FIG. 9 illustrate a payment truth table for the global offline payments system and method and an extended example of country-specific payment systems, such as UPI 1.0 and UPI 2.0 for India;

FIG. 10 illustrates how the offline global payment system and method adapts to support country-specific payment systems, for example the UPI system in India.

FIG. 11 illustrates how the offline global payment system and method adapts to support country-specific payment systems, for example the UPI 2.0 mandate request flow in India;

FIG. 12 illustrates how the offline global payment system and method adapts to support country-specific payment systems, for example the UPI 2.0 mandate execute flow in India; and

FIG. 13 illustrates an example of the payments request data schema.

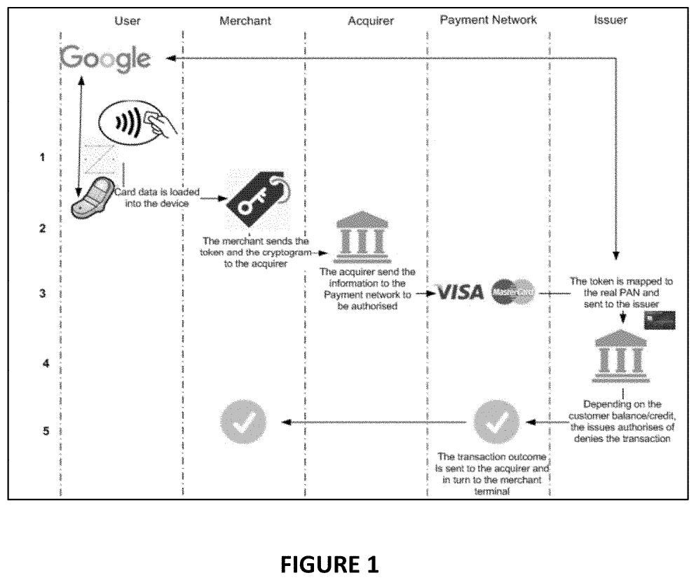

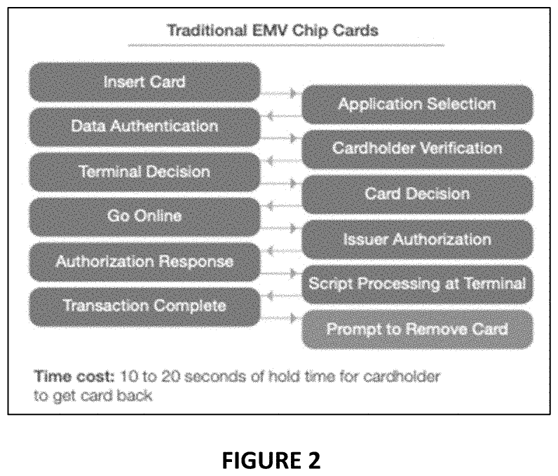

### DETAILED DESCRIPTION OF ONE OR MORE EMBODIMENTS

The disclosure is particularly applicable to an offline payment for an Edge computing appliance and/or a content delivery network (CDN) and it is in this context that the disclosure will be described. It will be appreciated, however, that the offline payment system and method has greater utility since it can be used with other content or commerce systems in which it is desirable to provide offline payments and it can be architected in other manner than the disclosed embodiments that are within the scope of the disclosure. The offline payment mechanism uses Edge computers installed within a Wireless or Wired network or a local area network of the user and cached wallet balance (pre-paid balance and/or post-paid credit) for a user on the user device. The Offline Payment mechanism then utilizes a SDK which is integrated by Digital services to resolve payments without Internet connectivity that can be verified at a later point in time, when the user device or the Edge computer gets access to internet connectivity. The Offline Payment Mechanism allows the current Payment Infrastructures to accommodate completely offline transactions, while retaining their security and ease of use for customers.

The offline payment system and method provides a system so that users can transact on Digital services without any payment failures even in areas with bad or unstable internet connections or even in scenarios with no internet access via digital wallets (pre-paid and/or post-paid), debit cards/credit cards and UPI. Furthermore, users will be able to transact on Internet services/Apps even on disconnected/intermittently connected platforms installed in aircrafts, buses, trains, remote areas, etc. via digital wallets (pre-paid and/or post-paid), debit cards/credit cards and UPI. In one example, each intermittently connected location, such as aircrafts, buses, trains, remote areas, etc., may have a local Wi-Fi based system as part of the Edge server and the offline payment system that allows users to perform payment transactions even with the intermittent internet/connectivity access that would typically cause payment transactions to fail.

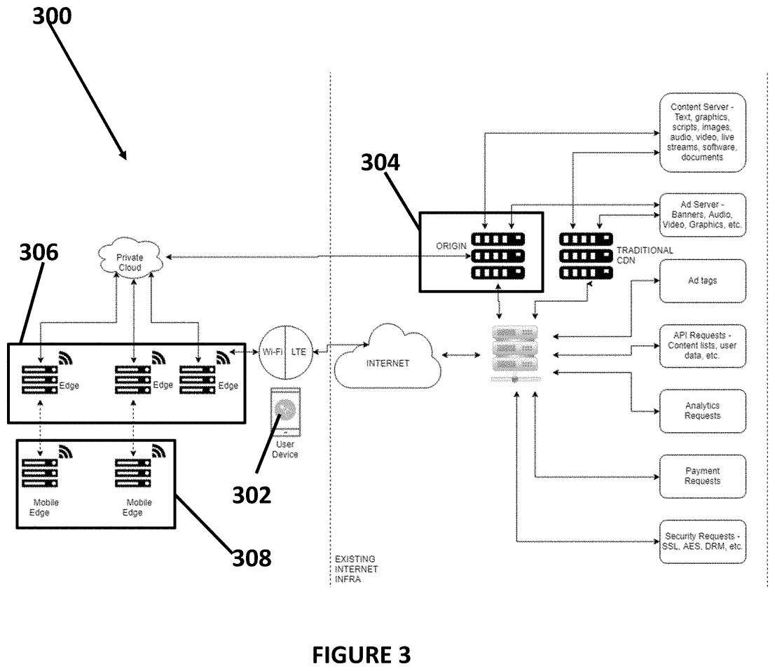

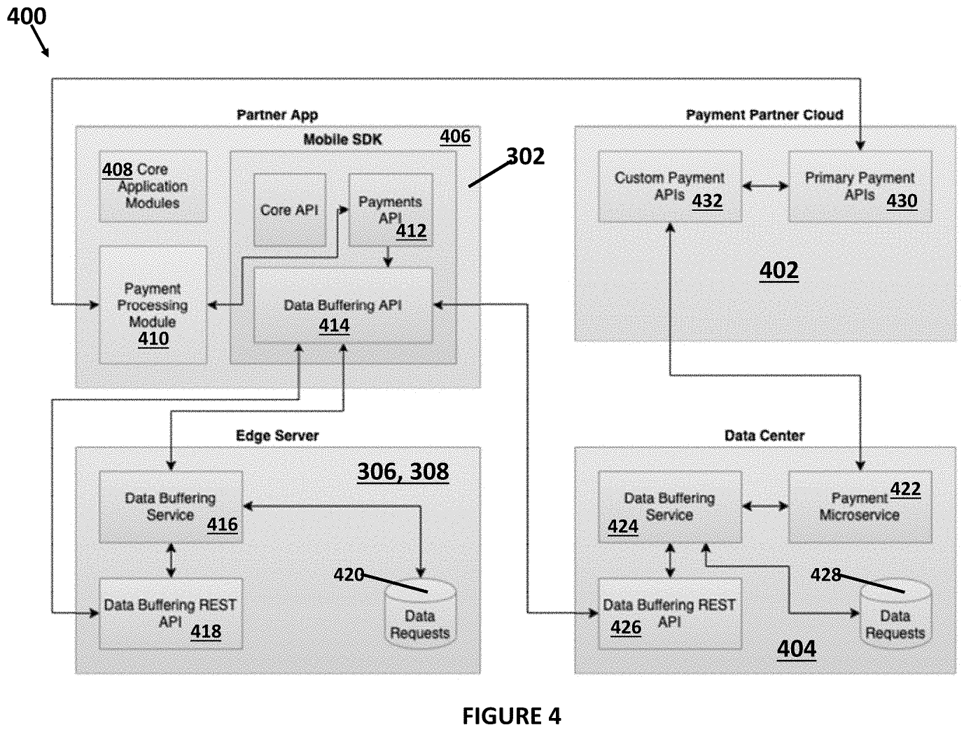

FIG. 3 is a hardware diagram of a content delivery network 300 that includes the offline payment system. The system 300 may further comprise one or more Edge computers 304-308 that may be connected to the internet or cloud infrastructure at an internet data center and may also be coupled to each computing device 302 of a plurality of computing devices over Wide Local Area Network (WLAN) or local Wi-Fi that provides an additional communications path for each application request. Each Edge Computer may be implemented as one or more server computers that are also equipped with a dedicated last mile over Wi-Fi. The CDN may include at least one CDN origin server 304, one or more mid-servers (not shown) and then one or more edge servers 306, 308 at the edge of the CDN. The mid-servers are between the origin server 304 and the one or more edge servers 306, 308. The offline payment system may be integrated into different elements of the CDN 300 such as the data center that houses the original server 304, the computing device 302, the edge server 306, 308 and a cloud payment platform as shown in FIG. 4 and described below in more detail.

As shown in FIG. 3, the CDN 300 may be connected to the existing internet infrastructure. However, with the attached dedicated last mile over Wi-Fi, the data from the CDN 300 may be delivered using a last mile which is outside the purview of the existing internet infrastructure (LAN) thereby freeing up bandwidth on the existing internet infrastructure, especially on the last mile provided by Internet Service Providers/Telecom operators and reducing the load of the existing internet infrastructure last mile with an increase in the number of users accessing or the consumption per user.

The CDN 300 enables a user that doesn't have access to the internet using any of the existing connectivity options (Internet Service Provider or Telecom operator) to experience whole or part of any Service. Furthermore, the offline payment system allows that same user to transact payment transactions even with no internet connectivity. The CDN 300 can continue to operate even when the connectivity of an Edge server to the CDN Infrastructure is unavailable as the last mile can expose the data cached on the CDN Edge to the Service, thereby allowing access to the Service in an area without reliable and sustained connectivity (transport, remote locations, etc.) The CDN Edge 306, 308 is always one hop away from the user (as it is available to the user over a Local Area Network) than a traditional CDN Edge, thereby providing a faster data delivery and facilitating better user experience.

The CDN 300 uses a dedicated last mile, whereas the last mile in the existing internet infrastructure is a shared last mile for the CDN and all the other services running on the internet, thereby providing a faster data delivery and facilitating better user experience. The CDN 300 operates on a last mile that operates on an unlicensed bandwidth, thereby making scalability of the last mile virtually unlimited, thereby enabling the Service to provide a guarantee to consumers on the availability, reliability and bandwidth availability while using the Service.

Each CDN Edge 306, 308 may be placed at Places of interest (Buses, Trains, Aircrafts, Malls, Commercial Centres, Airports, Cafes, Restaurants, Bars, Hotels, Educational Institutes, Hospitals, Clinics, Residential Complexes, Corporate Parks, Public Parks, Theme Parks, Public Places, etc.), which provides a service to make the experience contextual to the user based on the proximity of the user to a place of interest, without using the location of the device.

In more detail, the novel CDN system 300 may have one or more Origin & Mid Servers 304 which reside inside an Internet Data Center. These servers operate similar to a traditional CDN/cloud setup. The system 300 may also have one or more Static Edge(s) 306 which is connected to the cloud CDN 304 using physical high speed connectivity (P2P/MPLS) and has an attached Wi-Fi setup exposed to the user and one or more Mobile Edge(s) 308 which from a hardware and software stack standpoint is the same as the SB Static Edge, but instead of having physical connectivity to the CDN 300, it is connected wirelessly using one of the two routes: 1) using MPLS/cellular data connectivity over a telecom network (may be intermittent and may not be high speed); or 2) using Wi-Fi and the corresponding physical connectivity from an Edge 306, 308 (Is always intermittent when the Mobile Edge comes in the network of a Static Edge and is high speed).

A digital service requires access to the following 6 elements to function: API Requests/HTTP Requests; Security Requests—DRM/AES/SSL; Analytics Requests; Content Requests—Content/Downloadable Objects/Web Objects; Ad Requests; and Payment Requests. Generally, Analytics, Payments and Security requests are served directly by the Service Provider through their own/third party servers. All other requests are fronted by a CDN as shown in FIG. 3. In this system, the offline payment system also operates to provide a technical solution to permit offline payments in the CDN 300 or any other system in which it is desirable, to be able to receive payments even with no or limited connectivity, wherein traditional payment methods would fail.

In one example, the novel CDN system 300 may be implemented in a particular configuration of hardware and software. The Cloud CDN 304 may include compute servers, storage servers and networking equipment and the Static & Mobile Edge 306, 308 may include compute+storage Server, networking equipment and Wi-Fi Equipment. Each computing device 302 may be a smartphone type device that executes Apps (such as an Apple iPhone or Android operating system device and the like) that has a processor and memory that may store instructions that may be executed by the processor. The Origin & Mid 304 and each edge 306, 308 may also include content serving software, DNS, DHCP, logging & monitoring software and databases.

FIG. 4 shows more details of the system in FIG. 3 and in particular the offline payment system 400 that may be part of or integrated into the CDN 300 shown in FIG. 3 in one embodiment. In the embodiment shown in FIG. 4, the offline payment system 400 may be implemented using resources on the computing device 302, resources on the edge server(s) 306, 308, resource in the payment partner cloud 402 and resources in a data center 404 that are interconnected as shown in FIG. 4. The solution 400 makes use of APIs provided by the payment partner(s), and uses data buffering as a mechanism for forwarding payment requests in an intermittently connected environment as explained in detail below.

The data buffering mechanism creates and forwards requests in an intermittently connected environment. An SDK 406 on the computing device 302 of a user (implemented as a plurality of lines of instructions executed by the processor of the computing device to cause the processor perform actions or in hardware) creates such payment requests within an integrated app and sends the request to the cloud infrastructure 404 from the Edge Server 306, 308, depending on the availability of connection. If using the Edge Server 306, 308, then such a request is transferred to the Data Centre 404 from the Edge Server 306, 308 when it gets connected. The Data Center 404 has the necessary setup with payment partners wherein it understands the payment request coming in from the SDK 406, and makes available API calls to the payment partner's end to initiate payments. After confirming the request, the payment partner responds back with the status of the request. Such statuses are then transferred to the user's device (SDK) 406 over the Internet whenever the user's device becomes online.

The SDK 406, such as a mobile SDK) may have core application modules 408 and a payment processing module 410 that receives data from the payment partner cloud 402 and receives data from a payments API 412 of the SDK that also has a core API and data buffering API 414. The data buffering API 414 of the SDK is connected to the data buffering API of the edge server 306, 308 and the data buffering API of the data center 404 and together implement the data buffering process that is part of the offline payment process.

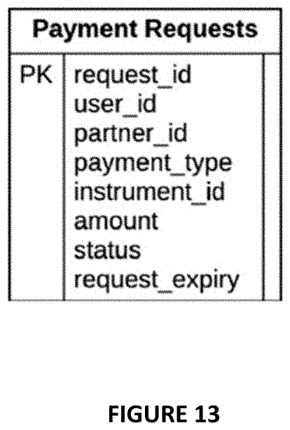

The Mobile SDKs 406 include the proprietary libraries that are integrated within the partner apps. They are the libraries that take care of the payment requests at the user's end. When connected to the Internet, the SDK 406 does send the payment request directly to the Data Center 404 via API calls. When not connected to the internet but connected to Edge Server 306, 308, the SDK 406 will send the payment request to the Edge Server 306, 308, which will in turn forward the payment request to the data center 404 services via an internal setup. Such payment requests generated at the SDK/application 406 may have an expiry time after which they will not be sent to the payment partner for payment processing, but they might still be sent out as expired/failed transaction requests. An example of the payment request of the system in FIG. 4 is shown in FIG. 13. The payment request may include the data fields shown in FIG. 13.

The edge server 306, 308 that partially the offline payment system is a node in the CDN that also provides the last mile connectivity to the end user. For offline payments flows, this acts as a middleware for the payment request. When a user is connected to the Edge Server 306, 308, Mobile SDKs 406 can create a payment request with a data buffering library as part of the SDK, this request is then sent to Edge Server in case the user is not connected to the internet through a data buffering service 416 and data buffering REST API 418 of the edge server that are connected to each other and connected to the SDK 406. The edge server 306, 308 may also have a store 410, such as a software and hardware database, for storing data requests and providing those data requests to the data buffering service 416.

The data center 404 that partially implements the offline payments system may have/host a payment microservice 422 that is connected to the payment partner cloud 402 and a data buffering service 424 and the data buffering service 424 may be connected to the data buffering REST API 426 and the store 428, such as a software and hardware database, for storing data requests and providing those data requests to the data buffering service 424.

The payment microservice 422, when a new user signs up for an Organisation account, cloud infrastructure services 422 check the account availability at the payment partner 402 with necessary authentication and authorization. The payment microservice 422 may then fetch the wallet balance of the user and saved instruments' with masked details and save it at the Data Center 404. Such information will be used to create the necessary UI at the integrated application. This service is also responsible for synchronization of the wallet balance and updated saved instruments' details at regular intervals. The payment microservice 422 will be responsible for processing the payment requests coming in from the Mobile SDKs 406 integrated with the partner application or the Edge servers 306, 308. As requests come in from the SDK 406 or Edge Server 306, 308, the payment microservice 424 will start processing the request if it is not already expired. Depending on the request type, the payment microservice 424 will initiate the payment processing. E.g. if it's a debit from a Payment Wallet, it will send required data to the payment partner backend with available APIs. Depending on the transaction status, the payment microservice 424 will send back the status to the SDKs 406 via silent notifications. The SDKs 406 can then fetch the latest transaction details from their own cloud APIs for updating their local states using the payment processing module 410.

The payment partner 402 is a the same entity who runs the offline payment system described above or a third party entity who runs/manages/owns known and commercially available payment gateways. The offline payment system partners with such entities for payment processing. For intermittently connected transactions, the offline payment system may have the typical primary payment APIs 430 and one or more custom APIs 432 due to the nature of payment processing. The payment microservice(s) 424 at the Data Centre 404 will be using such custom/special APIs to initiate transactions with the payment partner 402. The “Debit Transaction API” between the client, Edge/Data Center will pass the following parameters: User ID, Payment Instrument Identifier, User Token, Request Signature, Debit Amount, Expiry Timestamp, Transaction Initiated Timestamp. The “Payment System Refresh API” between client and the Edge/Data Center will pass the following parameters: User ID, User Token, Payment Request ID. The Edge will forward these API requests to the Data Center to process requests via Data Buffering, in case of non-availability of internet with the client.

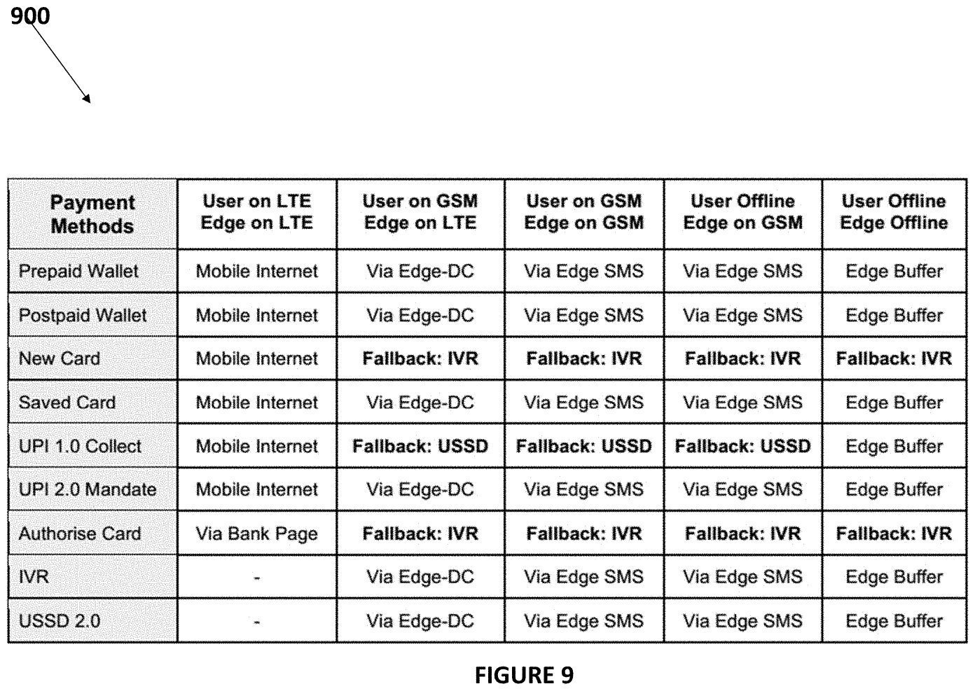

The data buffering (implemented using the data buffering elements 414, 416, 418, 424, 426) is a mechanism to store and carry forward payment requests for post processing. Such payment requests (example of the data schema of which is shown in FIG. 13) originate from the Mobile SDKs 406 which are integrated into the partner apps. These payment requests are stored locally for reference, and are passed onto the Data Center 404, directly or via an Edge Server 306, 308 depending on the available connectivity. In case of availability of connectivity, the system may route the payment request via LTE. In case of non-availability of LTE, it will fallover to GSM to route the transaction details using SMS Relay. The payload for the payment request will be encrypted and packaged as an SMS to be transmitted to the Data Center. This is a synchronous way of sending payment requests. Response is expected via separate and direct communication between the Data Center 404 and the Mobile SDKs 406 through the data buffering APIs 414, 426. In the system 400 in FIG. 4, the success ratio (the more successful payment mechanisms) of each payment mechanism (See FIG. 9 for a chart of an exemplary set of payment mechanisms) are chosen along with the data buffering. In more detail, in case of availability of internet, the Partner App 302 will make the decision to route the transaction over LTE. In case of non-availability of LTE, the Partner App invokes the Mobile SDK 406 to pass the transaction details to the Data Buffering API 414. The Edge server (306, 308) makes the decision to route the transaction request via Data Buffering in case of non-availability of LTE connectivity.

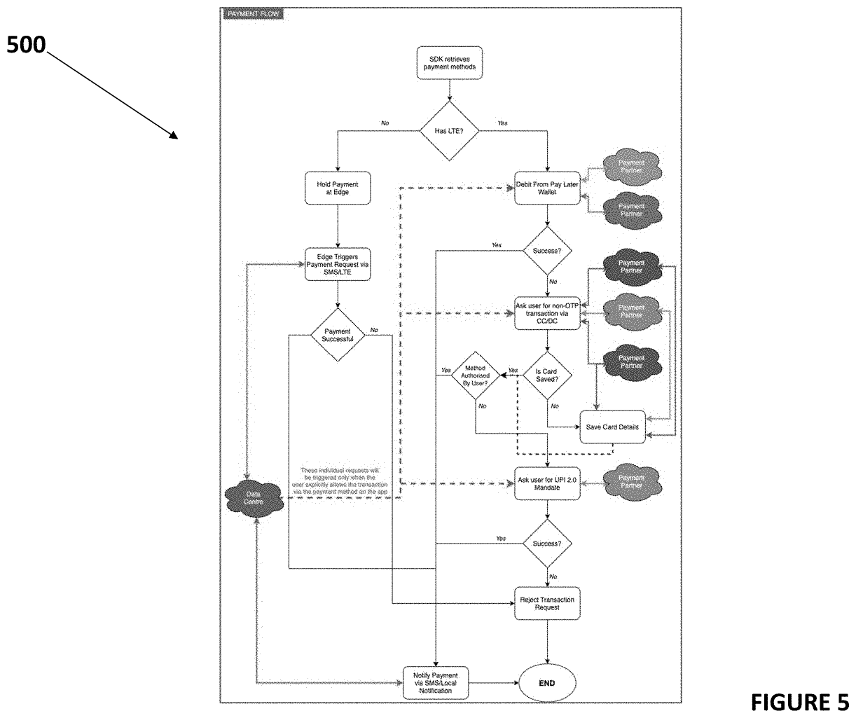

FIG. 5 illustrates a novel method 500 for global offline payment processing. The Offline Payment mechanism and method integrates with existing payment solution providers (Payment Wallet companies/Payment gateways) at the backend, wherein, it calls Payment Partner APIs to ensure that transactions are processed and propagated as soon as internet connectivity is available on the user device or the Edge server. The method shown in FIG. 5 may be implemented by the offline payment shown in FIGS. 3-4 above, but may also be implemented in other systems. It is important to note that the offline payment processing system and method may be used for various different global payment protocols as shown in FIG. 9 and may further include country-specific payments protocols or systems, such as UPI 1.0 and UPI 2.0 as shown in FIGS. 9-12 and described below.

In the method 500, customers, already equipped with arbitrage such as pre-existing Wallet balance or applicable Credit limits (Postpaid wallets), will be able to transact up to the total arbitrage amount (Pre-existing wallet balance+applicable credit limit) with offline payments. Each customer who has the partner applications installed on the computing device being used by the customer will include the Offline Payment SDKs 406 within each partner payment application. Using the Offline Payment SDKs 406, partners 402 will communicate with the Edge Servers 306, 308 using secure known protocols.

In a typical scenario, an offline transaction process may include the customer/user having his arbitrage (either pre-existing wallet money and/or an applicable credit limit) stored in obscure, encrypted Data stores on the user computing device—Imagine a secure passbook, which will encrypt and store all previous transactions (at least the last 20). The user chooses to transact on a Digital service with the Offline Payment SDK 406 using the Offline Payment mechanism. The authenticity of both, the Edge server 306, 308 and the computing device 302 may be computed separately via cryptographic signature verifications (such as 256 bit encryption with salted signatures and verification on the backend), after which the transaction validity will be calculated and stored on the computing device.

If the transaction is a valid request and satisfies the arbitrage criteria (user has sufficient funds), then the Edge Server 306, 308 APIs 418 may be triggered in order to carry out the transaction. Once the transaction is validated by the Edge Server 306, 308 internal verification algorithms, conceived and improvised along with the Payment Partner's rules, the customer will be returned a successful transaction UI. The UI will enable a one-click payment for usage of payment systems which satisfy the arbitrage criteria. The internal verification algorithm will do a soft-check with the Edge server to refresh and validate availability of arbitrage just-in-time. In case the arbitrage has been updated and does not satisfy the required transaction amount, the user will be notified of the same and the previously successful transaction will be reverted. In the offline payment process, identical and critical details of the transaction will be buffered on to both, the computing Device 302 and the Edge Server 306, 308. For example, the JSON payload will be buffered. The JSON payload may include a unique request id, payment details payload, user details, partner id, timestamps, expiry time, and the request signature.

Both the devices (computing device 302 and the Edge server 306, 308) will keep trying to send the data to a centralized cloud backend 402. Specifically, each transaction request will have an expiry associated with it. If the payload is transferred and received by the partner by the expiry timestamp, it will be used further in the transaction flow. If not, the transaction will be skipped and the user will be notified of a failed transaction. Once the offline transaction data arrives from either of the two possible routes to the Cloud backend 402, the backend 402 starts reconciliation of the transaction by calling the custom Backend APIs 432 exposed via the Payment Partners 402. The custom APIs would reconcile and set the right status/response for the same requests reaching partner backend via multiple routes i.e. direct from partner app using our SDK or via Edge-> our cloud backend-> partner cloud backend. Once the transaction is reconciled, the Edge Server 306, 308 will also be notified of the same, as well as the actual Payment Partner Online APIs called by their Platform Apps, will also now hold the fresh, validated arbitrage amounts and other details.

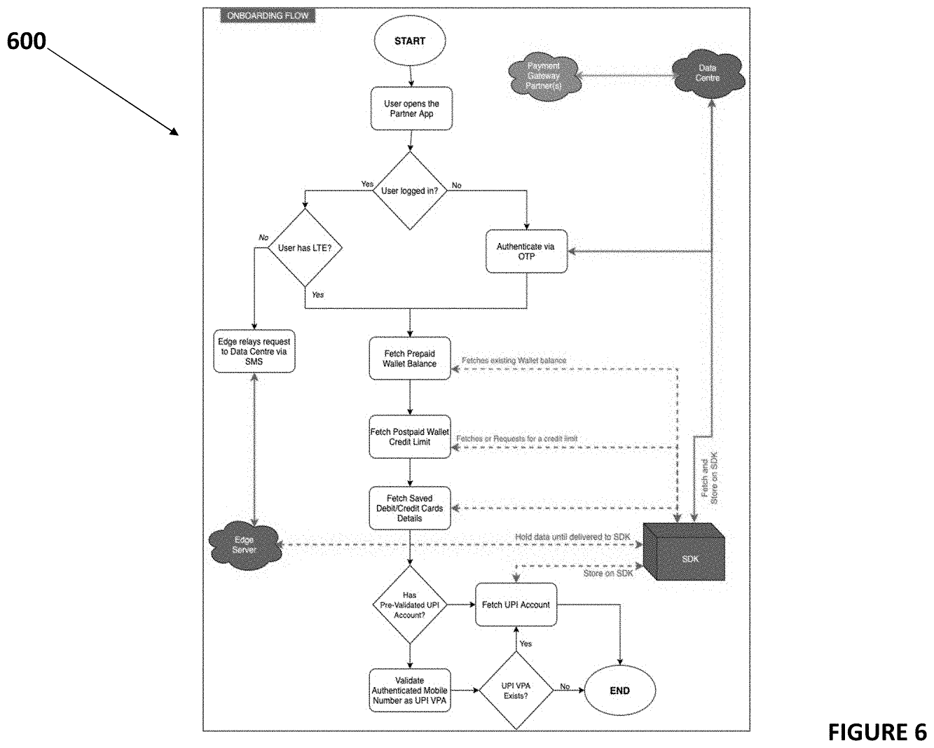

FIG. 6 illustrates a user onboarding process 600 for offline payments. A user's onboarding within the payment ecosystem will begin once the user has been authenticated via OTP or if the user is pre-authenticated by the Partner App and the SDK is supplied verified user details including, but not limited to, name, mobile number, email address. The mobile number, which has been authenticated by the Partner App, will act as the primary identifier for the user in the ecosystem. All further payments-related information will be mapped against the user using this mobile number/userID combination.

Once the mobile number has been authenticated, a series of steps will be executed at the Data Centre 404 for the user. In the onboarding process, the process may fetch the prepaid wallet balance, if any, for the user with the given mobile number. This prepaid wallet balance is a global balance—which means that this amount can be used by the user not only on the Partner App but any other app not a part of the ecosystem. Hence, this wallet balance may need to be refreshed at the Data Centre 404 or SDK 406 level.

The payment partner will also be provided with the user's mobile number and other demographic details identifying the ‘user persona’ for checking if the user has been pre-assigned a credit limit or if the user is eligible for a credit limit basis the user persona. These parameters will form the basis on which a credit limit may or may not be assigned. The usual TAT in notifying the credit limit would be between 2-5 minutes based on the user information available with the Payment Partner, their lending partner, credit bureau, etc. The assigned credit limit can be stored at the Data Centre 404 and the SDK 406 to run an offline ledger functionality. The mobile number may also be used to run a UPI VPA (Virtual Private Address) check to see if it's a valid UPI address and can be used to send a UPI Collect Request. The payment partner will also be requested to share saved card details (masked) that a user might have linked to their account. These options can then be used by the user by just entering the CVV to proceed with the transaction.

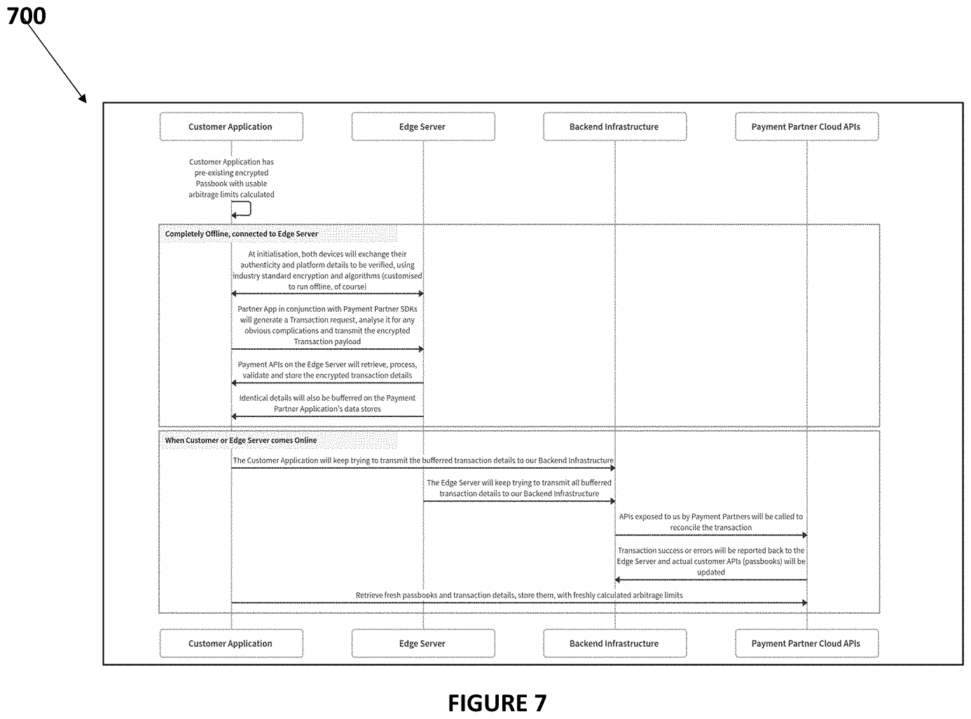

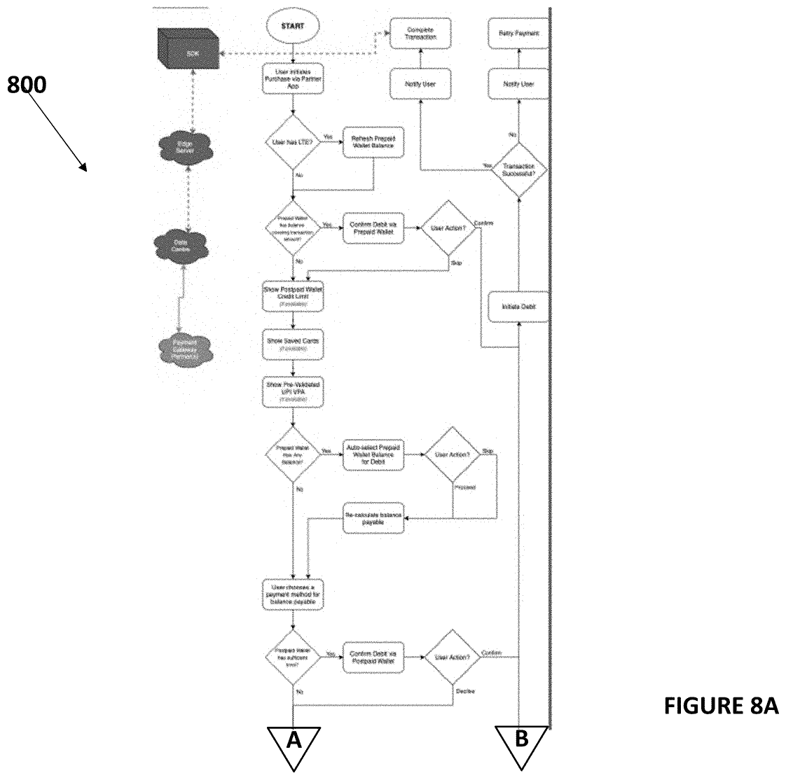

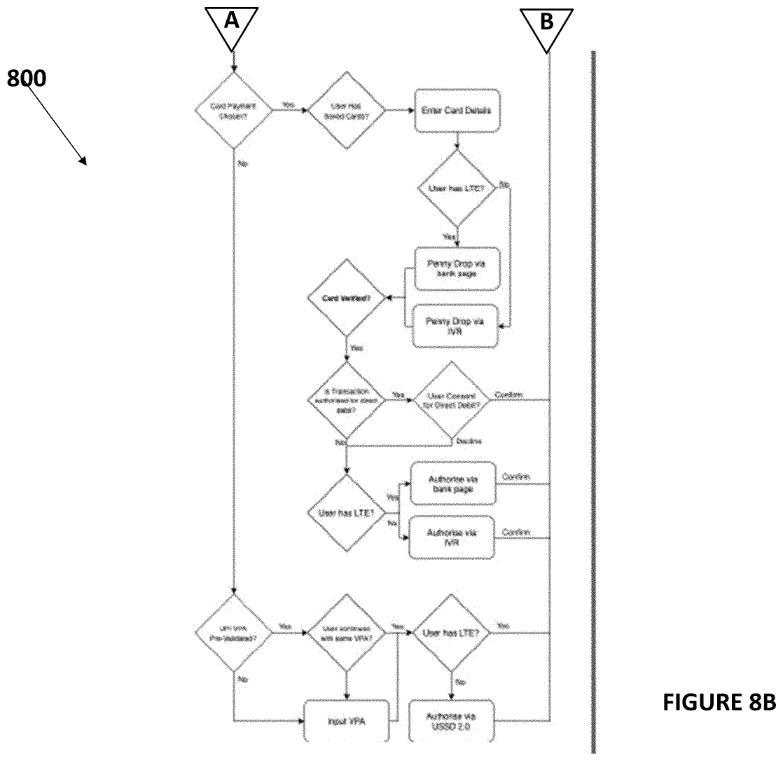

FIG. 7 illustrates further details of the architecture and information flow 700 for offline payments and FIGS. 8A and 8B illustrate more details of the transaction flow 800 for offline payments. For the offline payments, the payment ecosystem will support payments via Prepaid Wallet Balance, Postpaid Wallet Credit, Debit/Credit Cards and/or UPI in which the method used is prioritized in list order and each of the above methods has been prioritised for payment initiation on the basis of time to transact, success probability in an offline environment, number of API hits needed to execute a transaction and the need for internet connectivity. Each of the methods might also have a fallback mechanism in case of non-availability of the internet. For example, if payment method #1 (prepaid wallet) as shown in FIG. 9 fails, the method may fallback to method #2 (postpaid wallet) and so on with USSD 2.0 being the last fallback method, but also the poorest quality/speed method. The fallbacks form an integral part of achieving higher success rates for offline transactions and FIG. 9 explains the various fallback scenarios using a truth table.

When a user initiates a transaction for a product/service on the Partner App running the SDK 406 on the computing device, the user would be shown the payment options in the above priority. There may be cases, where the user might not be assigned a credit limit by the partner due to insufficient decision-making inputs for the user at their Decision Making Engine level. In such a case, the postpaid wallet payment method will not appear for the user.

In case the user has available prepaid wallet balance, that will be selected by default for deduction while transacting. The remaining balance to be paid, if any, will be shown to the user. Hence, the payment systems need to map multiple debit transactions against a single order. This will be important from a reconciliation/payment support standpoint. FIG. 7 illustrates the transaction and refresh mechanism for payment systems using arbitrage. This mechanism allows the payment SDK to stay updated with the latest arbitrage limits available for the user to carry out a transaction seamlessly. FIGS. 8A and 8B illustrate the internal decision making process while initiating a debit request for a transaction. It loops through the enabled and available payment systems with the user to show them as available payment options. The user then chooses to execute the payment request via their preferred payment system. For certain scenarios like usage of new credit card or debit card, the user may need to authorise saving the card details and future usage, which has been included in the decision making flow.

FIG. 9 illustrate a payment truth table for the global offline payments system and method and an extended example of country-specific payment systems, such as UPI 1.0 and UPI 2.0 for India. As shown in FIG. 9, for each payment method (shown in a first column including prepaid wallet and USSD 2.0) and each level of connectivity (shown in the first row including User and edge on LTE and user and edge offline), the truth table shows how the offline payment method handles the payment using the system in FIG. 4. Note that the payment methods in FIG. 9 are again shown in priority order with Prepaid wallet being the first choice and USSD 2.0 being the least prioritized/last choice used by the offline payment system. In this table, DC refers to the data center 404 in FIG. 4, user refers to the user computing device 302 and edge refers to the edge server 306, 308 in FIG. 4 while LTE and GSM and SMS refer to the data connectivity of these devices and offline is when a device has not data connectivity and would be unable to perform an online payment transaction. Further, fallback is a backup connection/payment processing method, such as IVR for the user and edge both on GSM for a new card. In addition, edge buffer (when user and edge are offline) means that the payment transaction data is buffed at the edge server (using the data buffering elements) until connectivity of the edge server is reestablished and the payment transaction data may be sent the payment partner. The “via edge-DC” in the chart denotes that the payment data may be communicated from the edge server to the data center since the edge server has LTE connectivity. As shown in FIG. 9, all the columns represent the connectivity status that may be prevailing at the time when user is trying to perform the offline payment and the process is to use available connectivity to complete the transaction with the mode selected. If connectivity is not available, fallback would be considered as mentioned in columns from left to right. e.g. for New card first column is the preference, will use connectivity either on users device or edge LTE to complete the transaction, else it will fallback to columns on right depending on the connectivity status.

As shown in FIG. 9, when both the user and edge have LTE connectivity, the mobile internet to which each are connected can be used to perform the payment processing, card authorization may be done via a bank web page and IVR or USSD 2.0 are not used. Thus, as shown in FIG. 9, the offline payment method can use various different prioritized payment methods (with prepaid wallet being the default) and various different methodologies for handling the payment data to ensure that the payment transaction can be accomplished even when there is no internet connectivity for either the user and edge server. As discussed above, at least some of the payment methods (UPI 1.0 and UPI 2.0) shown in FIG. 9 are country specific, in this case India, and the offline global payment method and system can operate even with country specific payment protocols and methods.

For example, for payment systems in India, Payment System Operators (PSOs) extend prepaid wallet functionality to users to allow them to load money and transact on merchant platforms. Similarly, the same PSOs may extend the postpaid wallet functionality, in association with a lending partner, which specializes in making credit limit decisioning for individual users. The card payment instruments of Credit Card and Debit Card are regulated by the Reserve Bank of India (RBI) for Card Not Present (CNP) transactions on digital platforms. RBI mandates use of CVV for all credit and debit card transactions, including saved cards. For all digital CNP transactions, the RBI also mandates usage of Additional Factor of Authentication (AFA), with the usage of One-Time Passwords (OTPs) generated by the card issuing bank. The requirement of AFA was relaxed for transactions up to [symbol] 2,000 by the RBI [https://www.rbi.org.in/Scripts/NotificationUser.aspx?Id=10766&Mode=0]. This allows for a direct debit being initiated for saved and authorised cards for which the user provides the CVV.

As another example, the Unified Payments Interface (UPI) is an India-specific instant and real-time payment system which allows P2P transactions between users using just mobile numbers or UPI Virtual Payment Address (VPA). This payment system framework has been developed by the National Payments Corporation of India (NPCI). The USSD 2.0 is built using the UPI Framework to allow for P2P transactions for users without requiring internet connectivity.

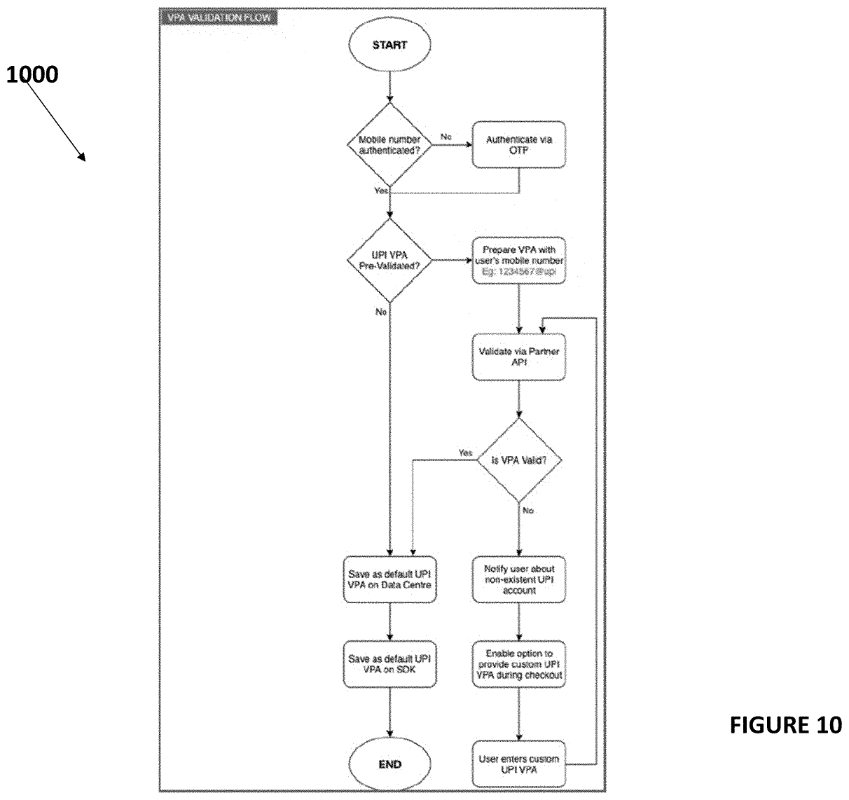

FIG. 10 illustrates how the offline global payment system and method adapts to support country-specific payment systems, for example the UPI system in India. More specifically, FIG. 10 a UPI validation flow 1000 for the offline payments method. During the UPI virtual private address (VPA) validation, the user's mobile number will act as a unique identifier for VPA Validation and the Data Centre 404 will initiate a VPA Validation through a PG Partner 402. In case UPI VPA exists, it will be mapped to the user's account for future transactions and the user will also be notified that their UPI VPA has been mapped. In case UPI VPA does not exist, the user will be requested to enter a custom VPA and this VPA will then be validated and mapped to the user's account. Thus, the proposed solution can be scaled as illustrated to solve for additional payment system as per country-specific requirements.

For a credit or debit card of a user, the user's credit card or debit card will be captured via an in-app form (payment partner's form with standard card fields like card number, cardholder name, expiry and CVV), that loads even without internet connectivity. The card details including card number, cardholder name, expiry and CVV entered using the form are notified to the Data Centre 404 directly or via Edge 306, 308 (SMS/LTE). During transit or during the hold, these details need to be encrypted. The first time the card is added, the user may need to do an authorisation (penny drop) that needs to happen when the user is connected to the internet. For fallback, the authorisation can happen via IVR, in case of non-availability of internet. Once authorised, the card details are saved with the Payment Gateway Partner 402 for compliance. Only a reference (payment identifier) to this payment is stored with the Data Centre 404 for compliance. For a debit transaction, the SDK 406 notifies this pre-approved payment method to be used against the transaction via the user ID, payment identifier and the debit amount.

For pay later wallets, once a user has been verified and onboarded, the mobile number is shared with the Payment Partners 402 for a credit limit check. The Partners may or may not assign a credit limit for the user. In case the limit is assigned, the limit details are saved at the Data Centre 404. This limit can be maintained as an offline ledger with the Data Centre 404 and the SDK 406. The Partners will also share repayment schedules, if any, for the user. During the repayment schedule, the user needs to be shown a reminder within the Partner App to make the payment via other payment modes and settle the outstanding amount.

When the user chooses to make a payment via UPI (illustrating usage for country-specific use cases such as India), their validated UPI VPA is sent a Collect request. This Collect request is initiated by the SDK 406 through the Edge-Data Centre route via SMS/LTE as per availability or is buffered at the Edge until connected. The Collect request can be given a short TTL/expiry of 10 minutes, during which the user may be allowed certain actions on the Partner App—for example, allow viewing the movie purchased through micro-subscription, till payment is confirmed. On the expiry of the TTL and in case the payment status hasn't been updated as successful, the user will not be allowed to continue their action further—for example, the movie cannot be watched further. On expiry, the Data Centre 404 will initiate a retry via the payment method chosen by the user.

In case of failure of payment via UPI, or in case the user is offline and cannot authorise a Collect request by entering the UPI PIN, the Collect request can be routed through Flash SMS using the known USSD 2.0 protocol (which is a country specific use case extended as a fallback mechanism for non-availability of internet). On sending a USSD Collect request, the user sees a Flash SMS with an option to authorise the transaction by pressing number 4 on the keypad. On clicking the number for selection, the user is requested to enter their UPI PIN via the Flash SMS. On entering a valid UPI PIN, the transaction is authorised and the Payment Partner 402 is notified. The Payment Partner will then relay this information to SDK 406 via Data Centre-Edge route.

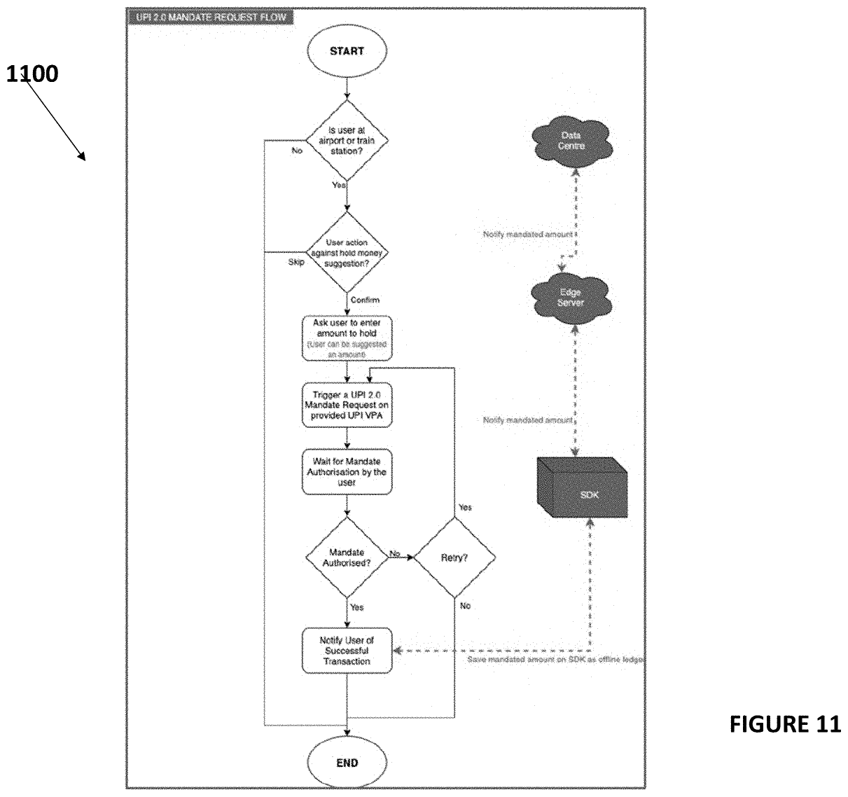

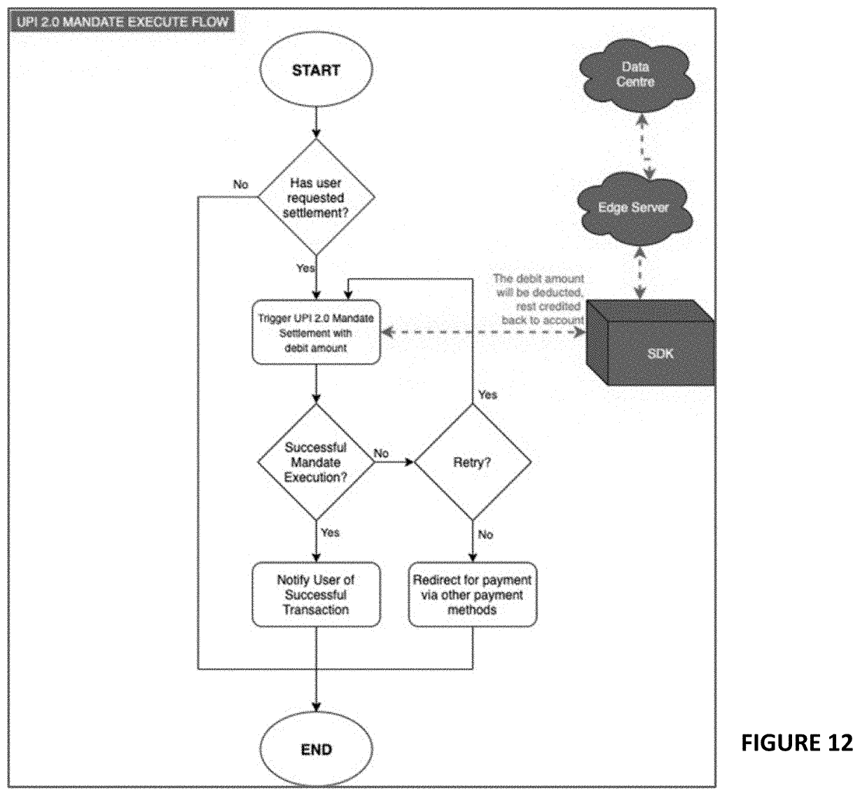

FIG. 11 illustrates how the offline global payment system and method adapts to support country-specific payment systems, for example the UPI 2.0 mandate request flow in India in FIG. 11 and the UPI 2.0 mandate execute flow specific to India as shown in FIG. 12. For certain use-cases, like in-flight payments, users can pre-authorise an amount to hold the money from the user's bank account. For this, the user can be notified to hold some money via UPI 2.0 Mandate, who may further agree to hold a certain amount by authorising a Collect request. The Payment Partner 402 will get a confirmation on the authorisation of the Collect request, which will be passed on to the SDK 406. The SDK 406, in this case, would receive an authorisation confirmation along with the amount held via the Mandate. This amount will act as a pay-later wallet for the user and the user can be allowed to transact up to this amount, even when offline. This amount stored offline will be managed by the SDK as an offline ledger. For each transaction, SDK 406 will notify the Edge 306, 308. When the Edge comes back online, it will notify the total transaction amount to the Data Centre 404 along with user details and transaction details. The Data Centre 404 will then initiate a Debit against the Mandate, causing the amount to be credited to the Integration Partner merchant account and the balance of the held amount, if any, will be instantly credited to the user's bank account.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A method for offline payment, comprising:
providing a location having intermittent connection to a digital network for transacting a digital service offline payment transaction using an offline payment computer system, the location having an edge server that provides a wireless connection at the location to a computing device of a user;
selecting, by the user, a payment process from a plurality of payment processes, each payment process having a plurality of payment transaction processes;
selecting, by the offline payment computer system, a particular payment transaction process for the selected user payment process, the particular payment transaction process selected based on a connectivity of the computing device and the edge server to a digital network; and
performing the offline payment transaction using the selected particular payment transaction process without a payment transaction failure regardless of the connectivity of the computing device and the edge server to the internet or the digital network.

2. The method of claim 1, wherein selecting the particular payment transaction process for the selected user payment process further comprises selecting a fallback payment transaction process for the selected user payment process if the particular payment transaction process is not available.

3. The method of claim 1, wherein selecting the particular payment transaction process for the selected user payment process further comprises selecting, when the computing device has GSM connection and the edge server has an LTE connection, a communication path from the edge server to the cloud infrastructure of the offline payment computer system.

4. The method of claim 1, wherein selecting the particular payment transaction process for the selected user payment process further comprises selecting, when the computing device and the edge server both have GSM connections, an SMS communication path of the edge server to the offline payment computer system.

5. The method of claim 1, wherein selecting the particular payment transaction process for the selected user payment process further comprises selecting, when the computing device is offline and the edge server both have GSM connections, an SMS communication path of the edge server to the offline payment computer system.

6. The method of claim 1, wherein selecting the particular payment transaction process for the selected user payment process further comprises selecting, when the computing device and edge server are offline, a payment transaction process in which the payment transaction is buffered in the edge server.

7. The method of claim 6 further comprising sending the payment transaction to the offline payment computer system when the edge server reestablishes connectivity.

8. The method of claim 1, wherein performing the payment transaction further comprises checking that the user has a sufficient balance to the payment transaction.

9. The method of claim 1, wherein providing the edge server further comprises a content delivery network having the edge server connected to the content delivery network, the content delivery network delivering the digital service to the user.

10. The method of claim 1, wherein selecting the payment process further comprises selecting the payment process from one of a prepaid wallet, a postpaid wallet, a new card, a saved card, a UPI 1.0 collect transaction, a UPI 2.0 mandate transaction, an authorize card transaction, an interaction voice response transaction and a USSD 2.0 transaction.

11. The method of claim 1, wherein selecting the payment process further comprises selecting a default prepaid wallet payment process.

12. The method of claim 1, wherein selecting the payment process further comprises displaying the payment methods on a display of the computing device.

13. An offline payment system, comprising:
a computing device of a user that has a processor that executes a plurality of instructions of a software development kit (SDK) to configure the processor to interact with a digital service and request a payment transaction;
an edge server, connected to the computing device physically or wirelessly, the edge server part of a content delivery network that delivers content to the computing device;
an offline payment system having a data center that is connected to the SDK and a payment system to execute the payment transaction requested by the computing device;
the processor of the computing device further configured to display a plurality of payment processes to the user who selects a payment process from a plurality of payment processes, each payment process having a plurality of payment transaction processes; and
the offline payment computer system further configured to select a particular payment transaction process for the selected user payment process, the particular payment transaction process selected based on a connectivity of the computing device and the edge server to a digital network and perform the offline payment transaction using the selected particular payment transaction process without a payment transaction failure regardless of the connectivity of the computing device and the edge server to the internet or the digital network.

14. The system of claim 13, wherein the offline payment computer system is further configured to select a fallback payment transaction process for the selected user payment process if the particular payment transaction process is not available.

15. The system of claim 13, wherein the offline payment computer system is further configured to select, when the computing device has GSM connection and the edge server has an LTE connection, a communication path from the edge server to a data center of the offline payment computer system.

16. The system of claim 13, wherein the offline payment computer system is further configured to select, when the computing device and the edge server both have GSM connections, an SMS communication path of the edge server to the offline payment computer system.

17. The system of claim 13, wherein the offline payment computer system is further configured to select, when the computing device is offline and the edge server both have GSM connections, an SMS communication path of the edge server to the offline payment computer system.

18. The system of claim 13, wherein the offline payment computer system is further configured to select, when the computing device and edge server are offline, a payment transaction process in which the payment transaction is buffered in a data buffering server of the edge server.

19. The system of claim 18, wherein the edge server sends the buffered payment transaction to the offline payment computer system when the edge server reestablishes connectivity.

20. The system of claim 13, wherein the processor of the computing device is further configured to check that the user has a sufficient balance to the payment transaction.

21. The system of claim 13, wherein the edge server provides the wireless connectivity to the computing device at a location and wherein the location is one of an intermittently connected platform.

22. The system of claim 21, wherein the intermittently connected platform is installed in one of an aircraft, a bus, a train and a remote area.
